(19) United States
(12) Patent Application Publication
(10) Pub. No.: US 2008/0103614 A1
(43) Pub. Date: May 1, 2008

(54) PREDICTION METHOD AND SYSTEM

(76) Inventors: Julian Ellison, Newport (IE); Yoshi Nishio, London (GB)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/868,136

(22) Filed: Oct. 5, 2007

Related U.S. Application Data
(60) Provisional application No. 60/850,215, filed on Oct. 6, 2006.

(51) Int. Cl. G06F 19/00

(52) U.S. Cl. 700/93; 235/375

(57) ABSTRACT

The future is a source of fascination to all of us. Large service industries, such as insurance and gaming, exploit our lack of knowledge about the future. The system according to the present disclosure taps into the same vein. It allows anyone to suggest outcomes to future events, and for anyone else to vote as to whether they agree or disagree with them. These votes can be purchased and the more votes spent, and the more outcomes successfully predicted, the more money a voter can make. The system facilitates this process through on-line and mobile technologies. Over time, the accumulated data will reveal trends about public attitudes and the extent to which fears and hopes about the future match the reality that transpires.

### PRIORITY

This application claims priority from a United States Provisional Patent Application filed on Oct. 6, 2006 and assigned U.S. Provisional Patent Application Ser. No. 60/850,215; the entire contents of which are incorporated herein by reference.

### FIELD

The present disclosure relates to a platform where people can predict the outcomes of future events of interest to them, and profit from their hunches. Over time, the platform can be used to extrapolate data about people's beliefs about the future and the degree of accuracy of their forecasts.

### BACKGROUND

We are all fascinated by what the future holds. Many people hold strong views on issues and events that may or may not happen, but up to now have not had the ability to put forward their views to a wider audience.

### SUMMARY

According to a first aspect of the present disclosure, there is provided a computer implemented method of enabling voting on predictions, comprising receiving a prediction, the prediction comprising a prediction statement and an outcome date; receiving votes from a plurality of voters supporting and opposing the prediction; determining the outcome; and distributing votes of the losing voters to the winning voters.

The prediction can be any statement to which a yes or no answer is possible.

According to a second aspect of the present disclosure, there is provided a system for enabling voting on predictions, comprising a computer configured to receive a prediction, the prediction comprising a prediction statement and an outcome date, the computer further being configured to receive votes from a plurality of voters supporting and opposing the prediction, wherein the computer is configured to received information specifying an outcome of the prediction and in response to the outcome, to distribute votes of the losing voters to the winning voters.

### BRIEF DESCRIPTION OF THE DRAWINGS

Embodiments of the present disclosure will now be described by way of example with reference to the accompanying drawings, in which:

FIG. 1 provides an overview of a system according to the present disclosure;

FIG. 2 is a flow chart illustrating the free prediction submission procedure;

FIG. 3 is a flow chart illustrating the cash prediction submission procedure;

FIG. 4 is a flow chart illustrating the free vote submission procedure;

FIG. 5 is a flow chart illustrating the cash vote submission procedure;

FIG. 6 is a flow chart illustrating the free prediction to cash prediction upgrade procedure;

FIG. 7 is a flow chart illustrating the free supplemental predictions submission procedure;

FIG. 8 is a flow chart illustrating the cash supplemental predictions submission procedure;

FIG. 9 illustrates the outcome declaration procedure;

FIG. 10 illustrates the votes/credits distribution procedure; and

FIG. 11 illustrates the floating votes calculation procedure.

### DETAILED DESCRIPTION

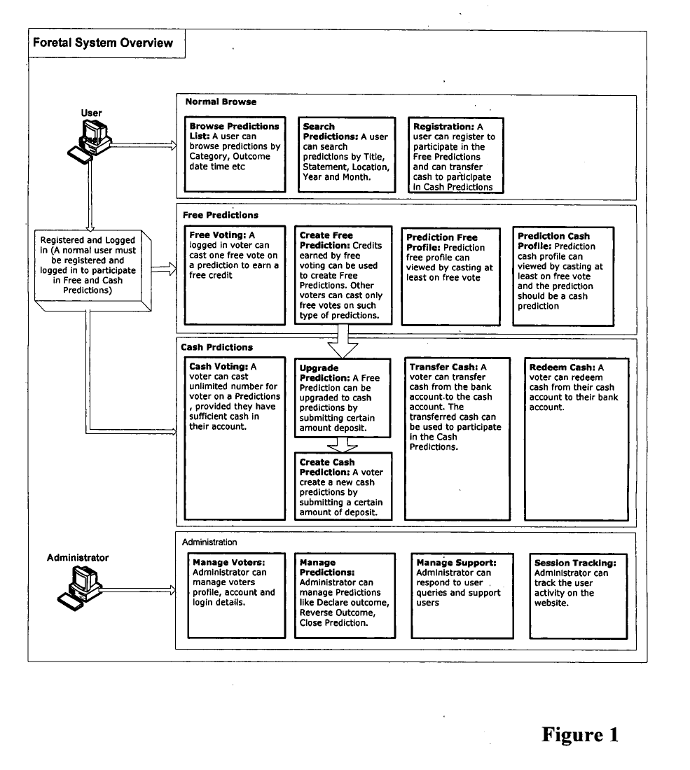

A system according to the present disclosure comprises one or more server computers accessible over the Internet from a plurality of client terminals, in a manner that is well known per se. The system is also referred to in this document as Foretal or Foretal World. An overview of the system is provided in FIG. 1.

Every visitor to the system according to the present disclosure is treated as a browsing visitor, also referred to as a browser. Anyone may browse the site, although logs will be kept of all incoming IP addresses, and Javascript will be used to establish a virtual session so that the duration of a browser's time looking round the site can be tracked, as well as the paths the user has taken, for subsequent analysis.

The browser is able to navigate to almost all the content of the web site but is suggested at every possible location to register. Whether registered or not, browsers can vote on whether they think a prediction will happen by the date the predictor proposes.

To become a registered voter, a person must confirm their e-mail address, then supply a real name and a nickname for the site. A password must also be confirmed.

No matter at which location the browser decides to register to the system web site, he is directed to the user registration procedure and can be redirected to the location they were navigating once the registration process is completed.

Having registered a voter can get full access to the site, review all categories and predictions as well as submit predictions and supplemental predictions of their own. They can download an application to their mobile phone which lets them participate on the move, and introduce others to the site as well.

A prediction is the keystone of the system according to the present disclosure. A prediction can refer to any future event, for which there is likely to be a definitive outcome by a specifiable time and date.

For example: Hilary Clinton will be President of the United States of America at midnight GMT on Jan. 1, 2009.

Predictions will be divided into Categories, for instance Nature, Innovation, Money, People, Power and Left Field. Predictions can be submitted to the system either by site managers (“House predictions”) or by registered voters (“Voter predictions”). In the present example, one prediction can belong to a maximum of two categories.

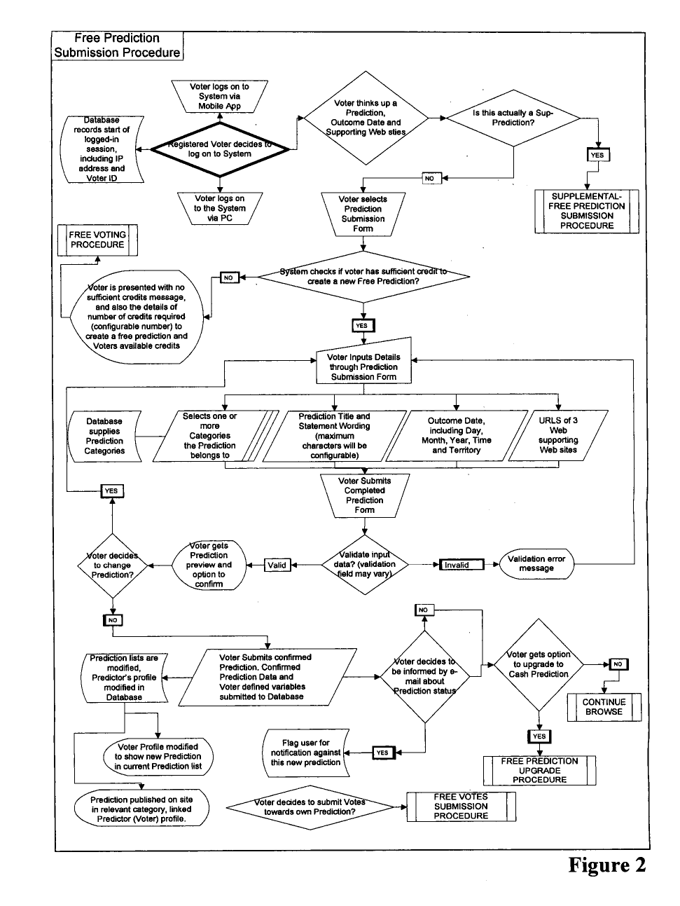

There are two types of prediction, a free prediction and a cash prediction. A free prediction is created using the free credits a user earns by engaging with predictions on Foretal. A free prediction can only accept free votes and each voter can cast only a single vote on the prediction. An example of the free prediction submission procedure is provided in FIG. 2.

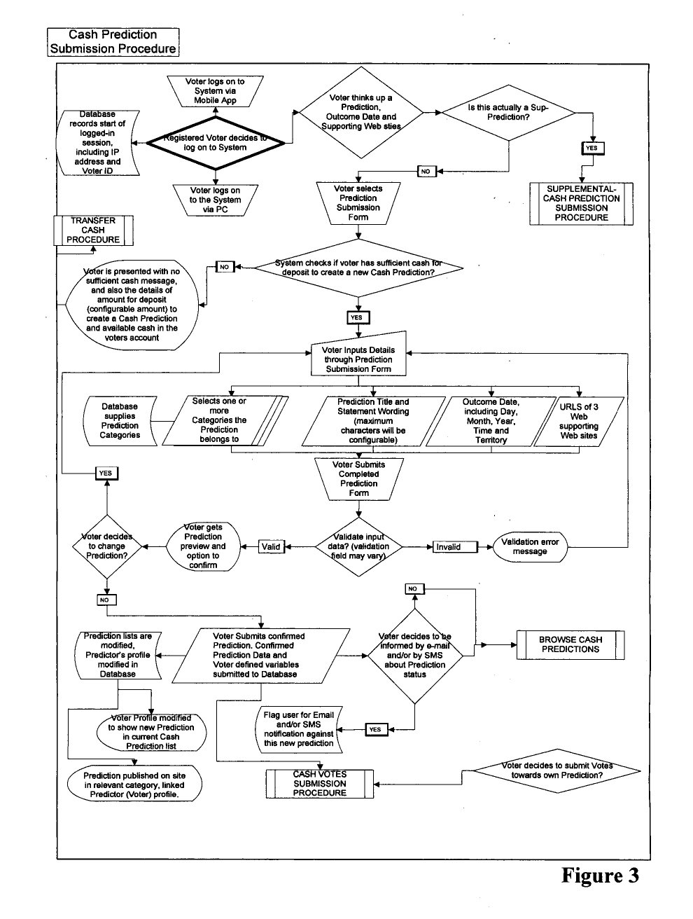

A cash prediction is created by paying a cash deposit, for instance [symbol] 5.00. A cash prediction can accept both free votes and cash votes and unlike other forms of prediction, more than one vote may be cast at a time by a voter. As many cash votes may be cast as a voter wishes to pay for. Each vote will cost a small amount, for example [symbol] 1.00. An example of the cash prediction submission procedure is provided in FIG. 3.

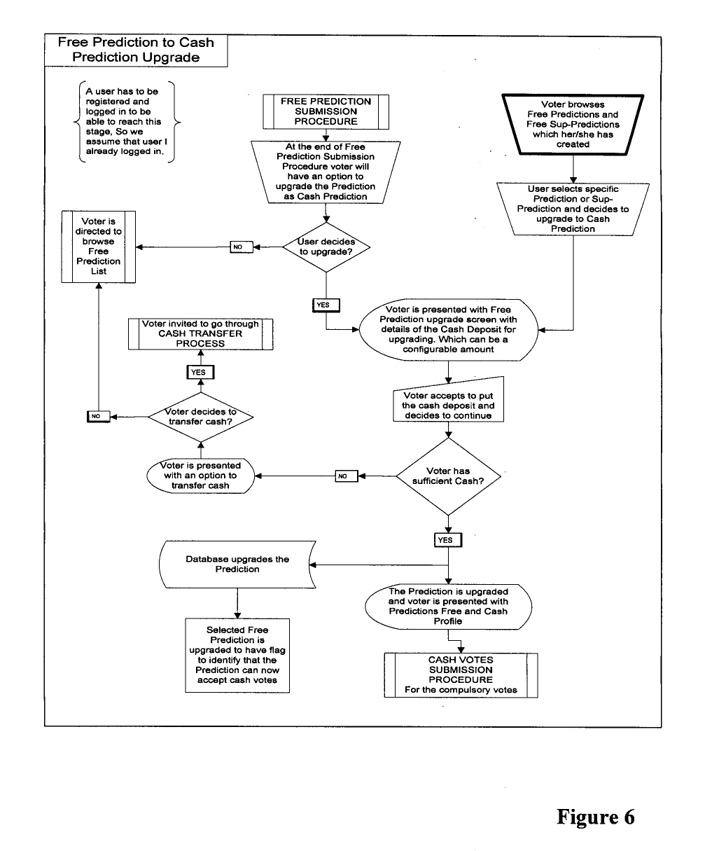

A free prediction can be upgraded to a cash prediction by the predictor paying the cash deposit. FIG. 6 illustrates a procedure for upgrading a free prediction to a cash prediction.

Whether registered or not, a user can cast a single vote on free predictions or free supplemental predictions for free, receiving a single credit for each free vote they cast. Credits amassed in this way can be used to pay for the submission of free predictions and free sub-predictions, which will be explained in detail below.

In addition, registered voters can purchase votes for use with cash predictions. These are the currency of the platform. Vote purchases can be made online using credit or debit cards and PayPal, or via SMS.

Voters will use votes to put up cash predictions (“the deposit”) and to support or reject existing cash predictions submitted by others (“the ballots”).

Each prediction, free or cash, has two ballots. The YES ballot contains the votes of those who believe the prediction will happen as predicted. The NO ballot contains the votes of those who do not believe the prediction will happen as predicted.

The outcome of a prediction can be declared by the system administrators on or before the prediction end date. The status of the prediction is updated to “declared”, therefore no more new votes are accepted.

In certain embodiments, there is a cooling period after the outcome is declared and before the outcome is confirmed of up to 24 hours. During the cooling period, the outcome can be reversed by the system administrators if required. After the cooling period, the outcome is confirmed and it cannot be changed anymore.

A prediction with a confirmed outcome is closed on the prediction end day. When an outcome is determined, either those who contributed to the YES ballot or those who contributed to the NO ballot will have lost. Votes are redistributed on closing. All votes in the winning ballot are returned back to the voters. In an embodiment of the system according to the present disclosure, votes from the losing ballot and floating ballot (which will be described in more detail below) are redistributed among the voters in the winning ballot and the predictor once a small percentage commission is deducted by the site administrator.

Votes are distributed to the winners' accounts in proportion to the amount of votes each voter put into the winners' ballot.

In an embodiment of the system according to the present disclosure, both free votes and cash votes are redistributed in the same way. Each free votes is redistributed as a credit. Therefore a user can earn additional credit either by my making a free vote or by the redistribution of free votes.

Voters on cash predictions will be able to redeem votes for cash or leave them in their account to participate in further cash predictions.

All registered voters are eligible to vote once on any free prediction at any level (Parent/Supplemental prediction) irrespective of the cash in their cash account or credit points. Every time a voter takes part in free voting they get one free credit added to their profile.

The credits amassed by free voting cannot be redeemed as cash but can be used as deposit for creating a new prediction or supplemental prediction. Ten credits, for instance, earns the right to post one free prediction.

There will be minimal editorial control over what predictions can be submitted. Offensive or indecent predictions may be removed by the site administrators or blocked from being published, but in general, voters are self-incentivised to submit predictions that are of general interest and where there is a balance of opinion as to the likely outcome. Such predictions are most likely to interest other voters and encourage them to contribute to the ballot. Predictions that are wilfully obscure or impossible to verify are unlikely to be submitted since they will only result in the predictor forfeiting their deposit.

An open prediction can be removed unilaterally by site administrators if it is offensive or illegal. Declared, Ended and Closed predictions cannot be removed.

In the event that a prediction is removed by the site administrators, all the cash votes in the ballots are returned to voters, and deposits are returned to the predictor. Free votes and awarded credits are not returned. Any supplemental predictions of the removed prediction are also removed.

In an embodiment of the system according to the present disclosure, site administrators can add up to three keywords and comments to a prediction from the admin site.

The primary interface for voters in embodiments of a system according to the present disclosure will be a website, but when a voter enters their own home page by submitting their account information, they are given the opportunity to browse predictions in a variety of ways, for example:
Overall or by category, listed with soonest outcome first.
Featured predictions. Featured predictions are those selected by site administrators as likely to be of particular interest to voters. They are listed by category or overall listed with soonest outcome first.
Most active predictions (by category or overall plus by the number of votes being contested listed with soonest outcome first.)
Newest predictions (by category or overall listed with soonest outcome first.)
Recent outcomes (i.e. determined outcomes of past predictions, by category or overall plus by number of votes contested listed with soonest outcome first.)
Predictions with outcomes in weeks, months, years and decades, or more specifically in 3 hours, 3 days, 3 weeks, 3 months, 3 years and 3 decades, 3 centuries and 3 millennia (by category or overall plus by number of votes contested listed with soonest outcome first.)

Up to 10 predictions, for instance, can be viewed in a single page list.

Each prediction when listed identifies the name of the user who submitted the prediction (“the predictor”), the number of voters who think the prediction will be YES or NO, and the aggregate number of votes in the YES and the NO ballots. The vote will be displayed as a pie chart, with additional information as to the percentage and number of participants in the vote.

The voter may click on the name of the predictor and ascertain statistical information about them, namely:
Date of registration as a voter.
Number of predictions submitted.
Number of predictions with definitive outcome
Number of predictions won by predictor
Number of predictions lost by predictor
Total number of votes submitted by voters to these predictions.

Voters will be able to decide whether they agree or disagree with the likely outcome of the prediction by voting YES or NO, adding votes from their account to the appropriate ballot.

Registered users are able to submit free predictions, using a ‘dialog form’ following the procedure that is illustrated in FIG. 2.

The form requires the user to include a title for the prediction of up to 25 characters and then a short statement about a future event in no more than 140 characters and to use drop down menus to pick a date and time by which this outcome must have happened. It must be possible to agree or disagree with the prediction by answering YES or NO.

The user must also pick a category into which this prediction will be submitted. The closer the prediction is in relevance to the category, the more likely others are going to respond to it. Up to two categories can be chosen for a prediction. Supplemental predictions do not need to be in the same category(s) as the parent prediction.

The user needs to choose what kind of prediction they are submitting, free or cash. In this case the user would select the ‘free’ option.

Assuming that the user has sufficient votes, the user can then submit the prediction. The deposit tariff for submitting a prediction, (e.g. 10 votes) is then deducted from the balance of the user's vote account.

The user can also, depending on their balance of votes, add additional votes of their own to support their own prediction. The user is then listed as the predictor when other voters view the prediction.

Finally, the predictor must choose from a list of commonly used websites (cnn.com, bbc.co.uk etc) the URLs of 3 web sites which are likely to provide independent corroboration of the outcome. Users may use other sites for corroboration, but again, if these are obscure or little known, the prediction is unlikely to attract many other voters.

A user can modify their prediction while they are going through the submission dialog, but once it is submitted, to get it removed, they must inform site administrators, who, will at their discretion, decide whether to remove the prediction. The deposit tariff will be forfeited.

Once submitted, the prediction is made available for all browsers to view and for other registered users to cast free votes on. In addition, other users are able to see a profile of the predictor—a short history of their previous submissions, if there are any, and the web sites which are being proposed as authenticators of the outcome.

The predictor receives a commission of 5% of the votes transferred from the incorrect (wrong) ballot to the correct (right) ballot in the event that the outcome of the prediction proves correct. Free votes are redistributed as credits to winning voters and the predictor.

This commission can rise to 7.5% depending on the number and success of the predictions a predictor submits, as explained further below.

predictions submitted by the user are prominently displayed in the user's home page when they return to the web site, and via a mobile application, which is explained further below.

Users create a cash prediction in the same way as a free prediction, apart from that they choose the cash prediction option rather than free prediction.

Before a user can submit a cash prediction, additional user information is, in an exemplary embodiment, required if the user is not already registered—notably, year of birth, city, nationality and gender.

Assuming that the user has sufficient cash, the user can then submit the prediction. The compulsory tariff for submitting a prediction, (for instance [symbol] 5.00) is then deducted from the balance of the user's account.

The deposit is, according to an embodiment of the present disclosure, distributed as follows: [symbol] 1.00 is retained by the site administrator. The remaining [symbol] 4.00 is used to submit cash votes into both ballots. Therefore, there will always be 2 Yes cash votes and 2 No cash votes on the creation of a cash prediction. (Same applies when a free prediction is upgraded to a cash prediction.) Those votes are treated as normal cash votes during redistribution, not as deposit.

The user then will have the chance to make a free vote or add more cash votes. The user is then listed as the predictor when other voters view the prediction. Once submitted, the prediction is made available for all browsers to view and for other registered users to vote on. In addition, other users are able to see who has submitted the prediction—a short history of their previous submissions, if there are any, and the web sites which are being proposed as authenticators of the outcome.

The predictor receives a commission of 2.5% of the votes transferred from the wrong ballot to the correct ballot after the outcome is declared and the prediction is ended.

This commission can rise to 7.5% depending on the number and success of the predictions a predictor submits.

Predictions submitted by the user are prominently displayed in the User's Home Page when they return to the web site, and via the Foretal mobile application.

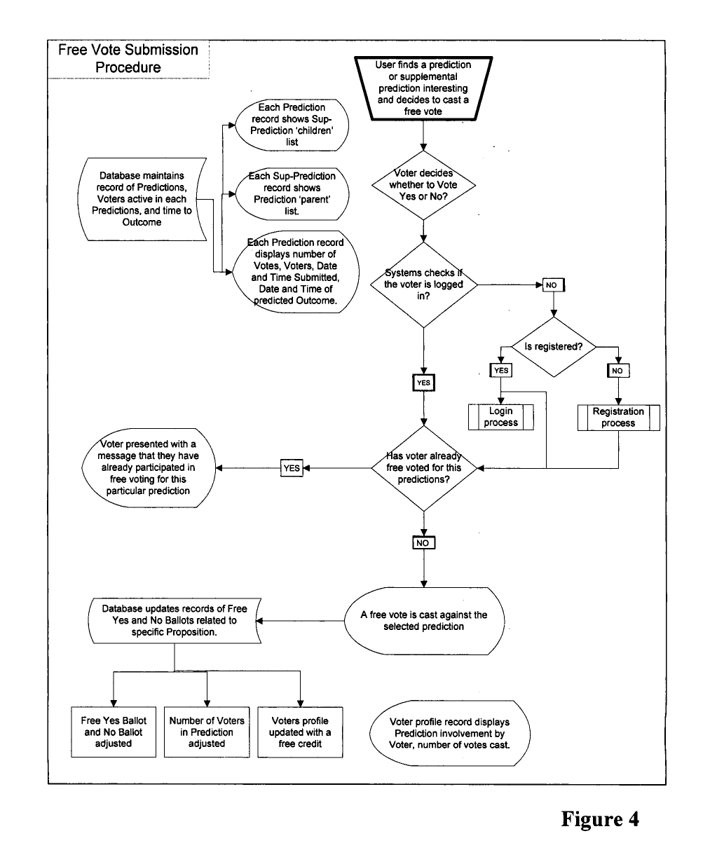

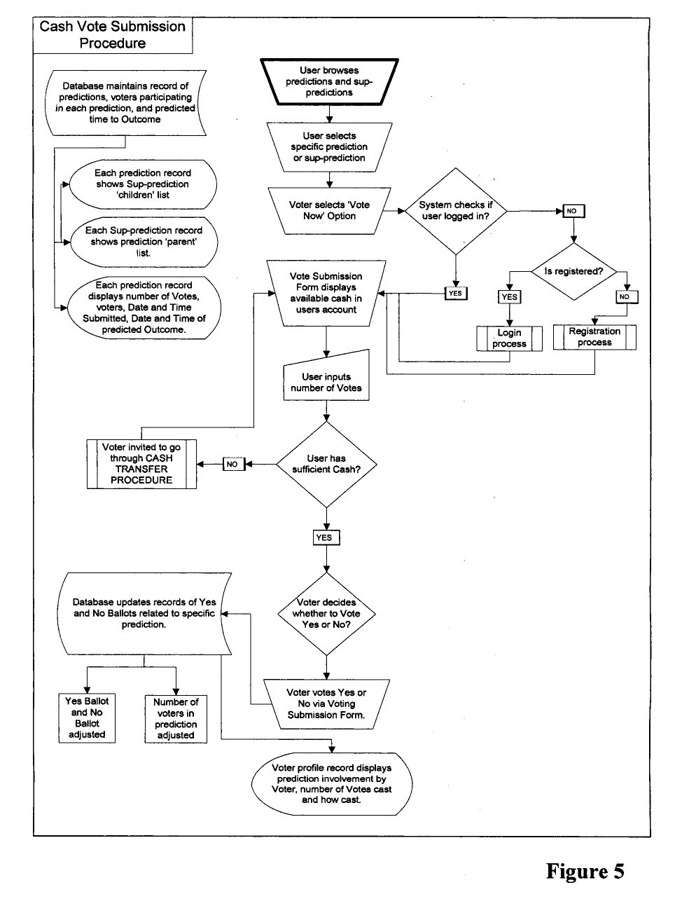

FIGS. 4 and 5 illustrate the votes submission procedures for free and cash votes respectively.

As regards cash votes, a voter can select any prediction from the lists of predictions, and decide whether to back YES or NO by clicking on the appropriate buttons. These take the voter through a ‘dialog form’.

The voter can either purchase new votes, or using existing votes they have to vote YES or NO. There is no limit on the number of votes that they can submit, provided that they are in the voter's account.

A voter can decide either to add more votes to support their point of view, or they can even add votes to the alternative point of view. No votes once submitted however can be returned until the outcome is determined.

There is no limit to when the future outcome can take place. In practice however, those predictions which are very far in the future, are unlikely to attract many votes because the chance of a return is so slight because the distribution of votes only happens after the prediction end date. Predictions will be organised into those whose outcome is in the next days, weeks, months and years.

Users may add supplemental predictions (SPs), also referred to as plus predictions, to existing predictions. The number of supplemental predictions that may be added to the prediction may or may not be fixed. The form and submission rules are identical to the posting of predictions, and the two are linked together by the phrase: ‘If this happens, then . . . . ’

For example: Hilary Clinton will be President of the United States of America at midnight GMT on Jan. 1, 2009. If this happens, then Bill Clinton will be Vice President of the United States on Jan. 1, 2009.

A supplemental prediction can be created either as a free prediction or a cash prediction regardless of what the parent prediction is.

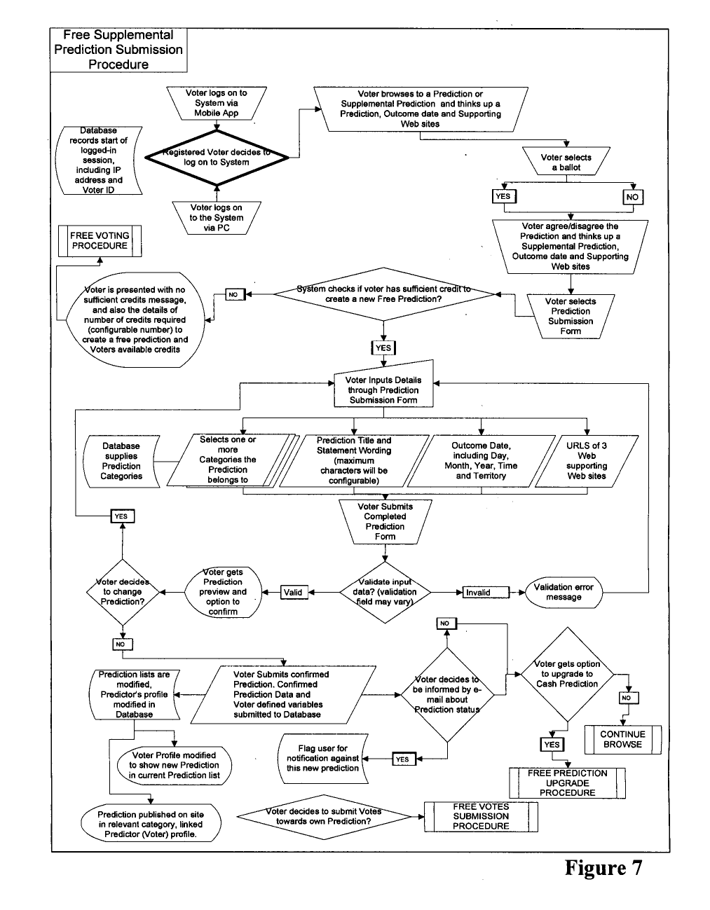

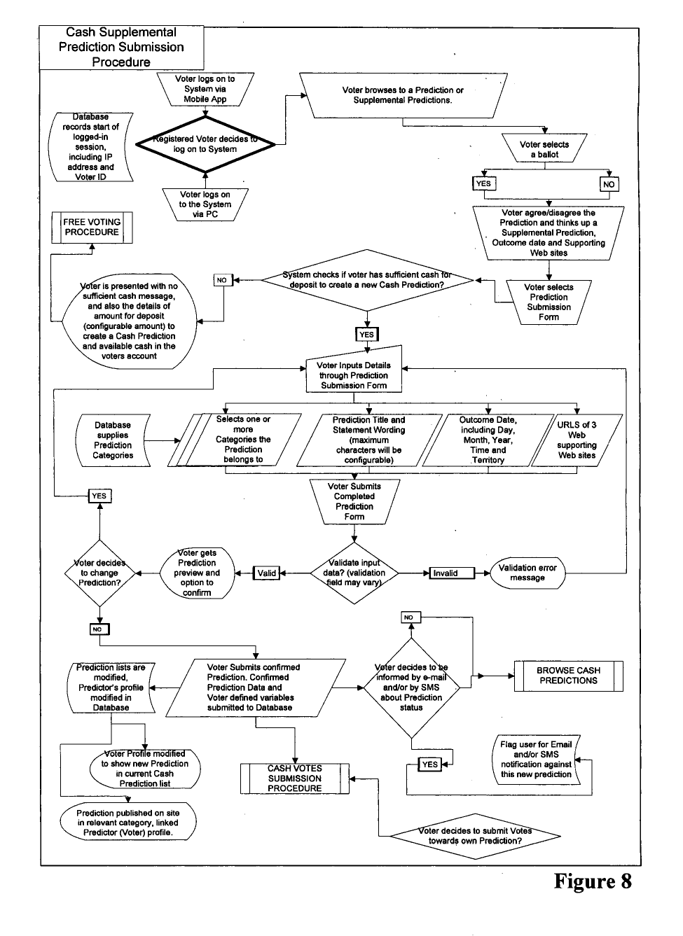

FIGS. 7 and 8 illustrate the free and cash supplemental predictions submission procedures respectively.

A user can create a single supplemental prediction in each level. For creating a supplemental prediction a user has to first select a parent prediction, then select a ballot under the parent prediction and then start creating the supplemental prediction.

For successful creation of a supplemental prediction a user must have, for example,
Voted in the parent prediction under which the supplemental prediction is being created.
Needs to have, for example, 50 (or variable number of) credits available in their account as deposit for supplemental prediction.

The steps involved in creating a new supplemental prediction are:
1. User selects a parent prediction and decides to create a new supplemental prediction based on one ballot.
2. User is presented with new prediction details page.
3. User enters the necessary details for new supplemental prediction.
4. User entered details are validated. If not valid, then the user is directed back to new supplemental prediction details page for correction.
5. If data is valid, the user is presented with confirm details page. If the details are not confirmed, then the user is directed back to new sup prediction details page for editing.
6. If confirmed, the business logic checks whether the user has voted minimum votes for the parent prediction. If not voted, then the user is directed to a vote for prediction process.
7. If user has already voted or voted via the vote for prediction process then the business logic checks for available credits for the deposit.
8. If there are no sufficient credits available, then the user has only one option:
   1) Save new prediction as provisional prediction.
9. If there are sufficient credits available, then the user has two options:
   1) Save as provisional prediction.
   2) Submit the prediction to other users.
10. If chose to save as provisional prediction the business logic saves the prediction as provisional supplemental prediction against the user's profile.
11. If chose to submit the prediction then the business logic submits the prediction to other users on behalf of the user.
12. In both the cases Step 10, 11, if the process was successful, the user is directed to prediction creation successful page. Otherwise, the user is directed to the error page.

Supplemental predictions may be added to either YES or NO outcomes. The maximum level of the supplemental predictions allowed on each thread can be configured.

Once the outcome of a prediction is determined, all supplemental predictions are converted to predictions, if their potential outcome is still valid.

A supplemental prediction may itself have a plurality of further supplemental predictions. In certain embodiments, two levels of supplementary predictions are allowed for each prediction.

Those who back the winning outcome of a prediction receive a pro-rata share of the votes of those who back the losing outcome.

Their individual share is a percentage based on an individual's number of votes submitted when backing an outcome compared with the total number of votes submitted by all voters on the winning side.

Operators of embodiments of the system according to the present disclosure return the deposit to the predictor if the prediction becomes true. A small commission is also taken by the operators on the votes from those who have backed the losing side.

FOR EXAMPLE: Hilary Clinton will be President of the United States of America at midnight GMT on Jan. 1, 2009. Do you agree?

People who believe this vote YES, putting a total of 10,000 votes into the YES ballot. People who disagree put a total of 12,500 votes into the NO ballot.

As the predictor, Bob pays a deposit of [symbol] 5.

John strongly agrees, so he casts (pays in) 200 votes, and so “owns” 2% of the “YES ballot”.

As he disagrees, Mike puts in 1,000 in the “NO ballot”, and has an 8% share of it.

OUTCOME: Hilary wins the 2008 election.
The deposit goes back to the predictor.
The YES ballot is returned to the voters who backed YES

The NO ballot (12,500 votes) is distributed as follows:

| | | |
|---|---|---|
| System commission | (7.5%) | 937.5 |
| Bob's predictor success fee | (2.5%) | 312.5 |
| Pro-rata to “YES” voters | (90%) | 11,250 |
| John's share | (2%) | 225 |

Bob has paid 5. He gets back 5+312.5.
John has paid 200. He gets back 200+225.
Mike has paid 1,000. He gets back nothing.
The system operator has collected 937.5 votes.

Free votes are distributed as credits the same way as cash votes.

The predictor is free to participate in the ballots on the same terms as other voters. In the example above, Bob could have increased his return by putting votes into the YES ballot. Alternatively, if he changes his mind over the duration of the prediction, he could put votes into the NO ballot to “hedge” against a negative outcome.

Whatever the outcome of a prediction, whether YES or NO, one outcome is now correct and the other incorrect. Any supplemental predictions which are contingent on a correct outcome remain live and the level 1 supplemental predictions become predictions in their own right.

A supplemental prediction contingent on an outcome that is now incorrect is eliminated, and their Yes and No ballots become “floating votes”. The deposits of the eliminated supplemental predictions are forfeited.

The “cash floating votes” are immediately transferred to a cash prediction in the same category(s) as the parent prediction with the highest number of voters (not votes) at the time of outcome declaration. They are distributed proportionally as a bonus to the voters who support the winning outcome when it is declared. The system operator takes a commission of 2.5% of the floating votes. If there are no other open cash predictions in those categories, the parent prediction will be selected.

In the same way, the “free floating votes” are immediately transferred to the prediction (which can be either a cash prediction or a free prediction) in the same categories as the parent prediction with the highest number of free voters (not votes) at the time of outcome declaration. They are distributed proportionally as a bonus to the voters who support the winning outcome when it is declared. The system operator takes a commission of 2.5% of the floating votes. If there's no other open prediction in those categories, the parent prediction will be selected.

If the outcome of the supplemental prediction is undecided or contested, the distribution of “floating votes” is held back until an adjudication has been reached.

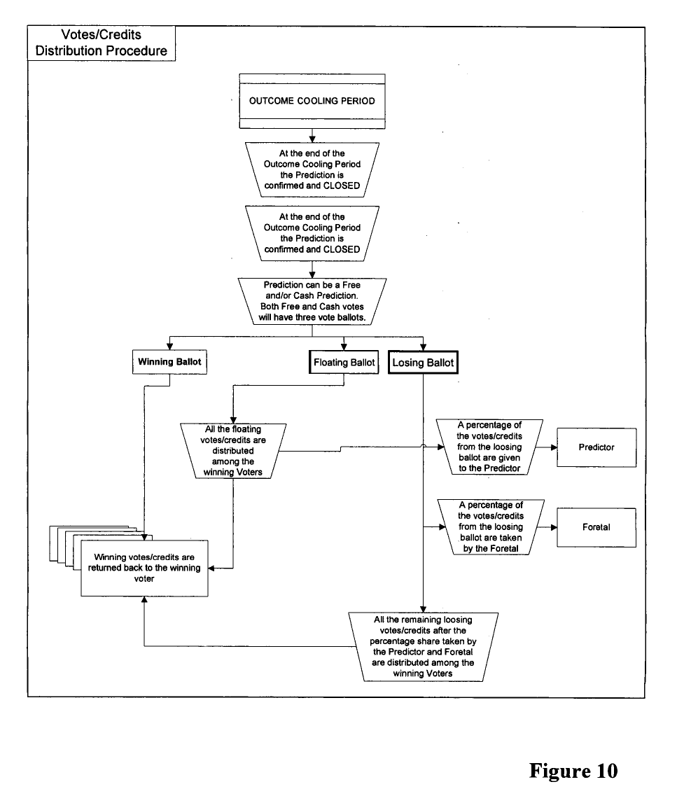

FIG. 10 illustrates the votes/credits distribution procedure.

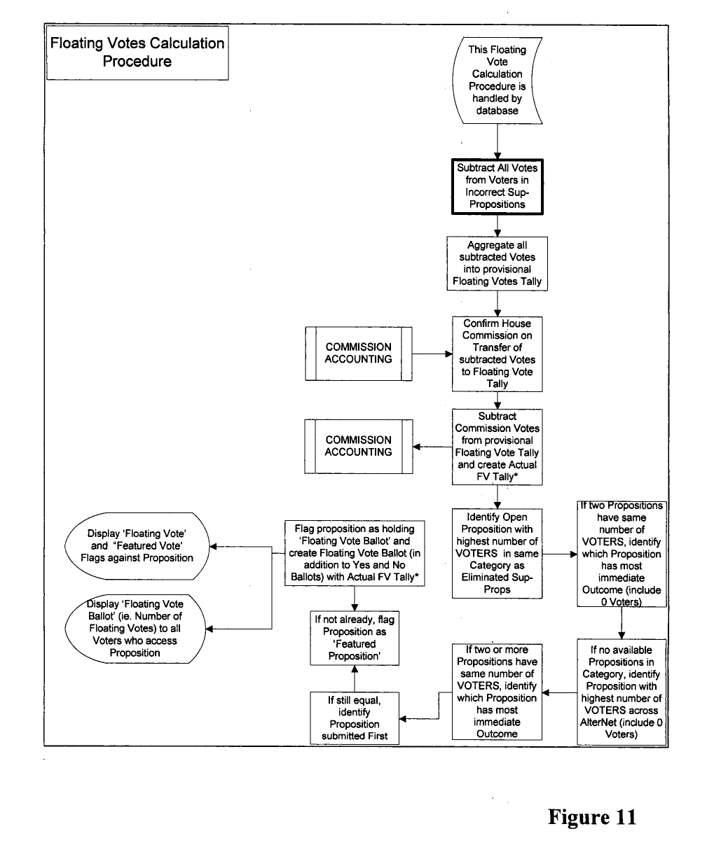

FIG. 11 illustrates the floating votes calculation procedure.

All predictions and supplemental predictions must have a definitive time and date by which an outcome must have been achieved. 3 web site addresses must be provided which will substantiate the outcome. If the administrators agree, an outcome is declared, and votes are distributed accordingly.

Votes can be submitted when the prediction is Open. If an outcome is determined before the prediction End Date, the prediction status becomes Declared, therefore the voting is stopped as soon as the outcome is declared. If the outcome has not been declared when the prediction End Date is reached, votes can be submitted until 60 seconds before the final time the outcome must take place. This time period can be varied by the site administrators.

By default, the effective outcome declared time is the same as the outcome declared time, which is the time an outcome is declared by a site administrator. However, according to embodiments of the present disclosure, the system administrator would reserve the right to set a retrospective effective outcome declared time which is the time when the outcome has been determined in the real world. Any votes cast after the effective time will be returned to the original voters.

If the outcome is simply not reached by the time stated by the predictor, then those who voted NO are the winners—even if the outcome is determined a few minutes later.

If the outcome is disputed, a dispute resolution procedure, is followed by the site administrators, as described below. Only when the site administrators are happy that a definitive outcome has or has not been established according to this procedure will the outcome be declared.

All supplemental predictions which follow on from a failed prediction are eliminated and labelled incorrect. All those supplemental predictions which follow on from the winning ballot are correct and remain active until they too have an outcome declared. Votes from these supplemental predictions are not included in the “Floating votes”.

When supplemental votes are disputed, the same procedure is followed as with a main prediction. Any votes that are distributed once an outcome is declared are distributed in the normal way to those who were participating in the relevant live predictions at the time.

Each user can submit one free vote to a free prediction, which will in turn earn the user a credit. Free votes allow user to participant in the voting without paying any cash. The credit earned can be used to create Free predictions to allow other users to start to use the system without paying.

Voters use their votes to back YES or NO outcomes to a cash prediction. Any number of cash votes can be submitted to any number of predictions. The higher the number of votes submitted to a prediction, the higher the potential share of any winnings.

A user can redeem cash from their Foretal account to a selected bank account.

According to certain embodiments of the present disclosure, the first time that a voter purchases at least 10 votes they are given an additional 2 votes free. However, voters may never redeem the last 5 votes in their account. Voters who decide to discontinue participation will be refunded the full redemption value of votes in their account less 5 votes.

Additionally, voters will receive 5 ‘free’ votes for each new voter whom they introduce to the system when that new voter purchases their first 10 votes.

Votes are bought through Credit, Debit Card and Paypal, as well as by either premium rate SMS and premium rate telephony drop charging. For example, 10 votes= [symbol] 1.00. An administration fee can added to the transaction. This administration fee can, for instance, be used to cover e-commerce commission fees.

Votes are spent submitting predictions and supplemental predictions, or voting Yes or No to the outcomes of predictions or supplemental predictions.

Votes are won or lost depending on the outcome of the prediction and whether one had votes riding on the successful outcome. All those who had votes on the losing side, lose their votes, which are distributed to those with votes on the winning side in proportion to the number of votes they submitted.

Votes can be redeemed at any time, with payments being made according to details stored on voters' profiles. Votes are redeemed at Par value, thus 10 votes= [symbol] 1.00.

There may be special redemption opportunities when voters are able to redeem their votes for an enhanced amount of cash. For example, “American Express™ sponsors double redemption up to $100 for first 100 voters who are card-members for the next 100 minutes” or “text REDEEM in the next ten minutes to receive double cash” in conjunction with a mobile network operator at times of day when the network is underutilised.

All voters will have a profile, viewable by other voters when they are the predictor of a prediction, that summarises their past activity—number and category of predictions posted, supplemental predictions attracted, total ballots cleared etc.

The top 5% of voters, based on the number of votes which have been submitted against predictions they have proposed by voters other than themselves, will receive a commission on votes from the losing ballot of 7.5%. The next 10% of voters will receive a commission of 5%. All others receive 2.5%.

The status of the predictor is calculated at the moment that a prediction is submitted. Predictors can lose their status if they do not remain in the top two bands of voters.

The site will publish daily a conversion rate for votes into major currencies such as UK Pound, Euro and Dollar. Free and bonus votes cannot be redeemed directly, they must be used to participate in predictions, and may yield votes off others. Any votes won or purchased may be redeemed at Par value i.e 10 votes=$1.00

Before votes can be redeemed, the voter must also confirm their address, their age and gender. This data will be used to extrapolate trends from the responses to predictions over time.

The site administrators are able to retrieve data on the number of people browsing, and voters for any time period since the site opened, to identify busy times of the day, as well as the most and least active categories, and the most and least active predictions. Site administrators can call up the specific information about an individual's account and usage patterns at any time.

A clear, fair procedure is in place to enable the predictor to substantiate the outcome, bring this to the attention of the site administrators and have them declare an outcome. The prediction must be validated by three reputable sources of on-line information that have been available for at least 12 months. If the site administrators are unhappy, they can either declare the outcome as they see fit, or they can void the entire prediction and return all votes whence they came.

It is up to the predictor to include the URLs of three Web sites which are likely to validate the outcome when it takes place. This is done at the point when the prediction or supplemental prediction is first submitted. At least two sites must definitively reference and describe the outcome.

The site administrators will review the sites mentioned, and if the outcome is substantiated declare an outcome.

Once the site administrators are content, they can use their site administration facilities to declare an outcome, whereupon votes are distributed. Provision can be made to reverse this process, in the event that the site administrators make a mistake. Voting is frozen at the earliest of outcome declaration or prediction end date.

After an outcome is declared, there is a configured cooling period (eg 24 hours) to allow the administrators to reverse the outcome in the event that the site administrators make a mistake or a dispute is taking place.

An outcome can be reversed during the cooling period and it has to be carried out by one of the site administrators. If the outcome is reversed, the prediction and all its supplemental predictions will be reversed back to the state before the outcome declaration. Floating votes will be returned back to the eliminated supplemental predictions.

After the cooling period (24 hours), all declared predictions will be confirmed automatically if they have not been reversed. After being confirmed, the outcome cannot be changed.

Votes of a declared prediction are redistributed at 00:00:00 on prediction End Date. If the prediction has ended before the outcome is declared, votes will be redistributed at 00:00:00 on the day after declaration (subject to the cooling off period).

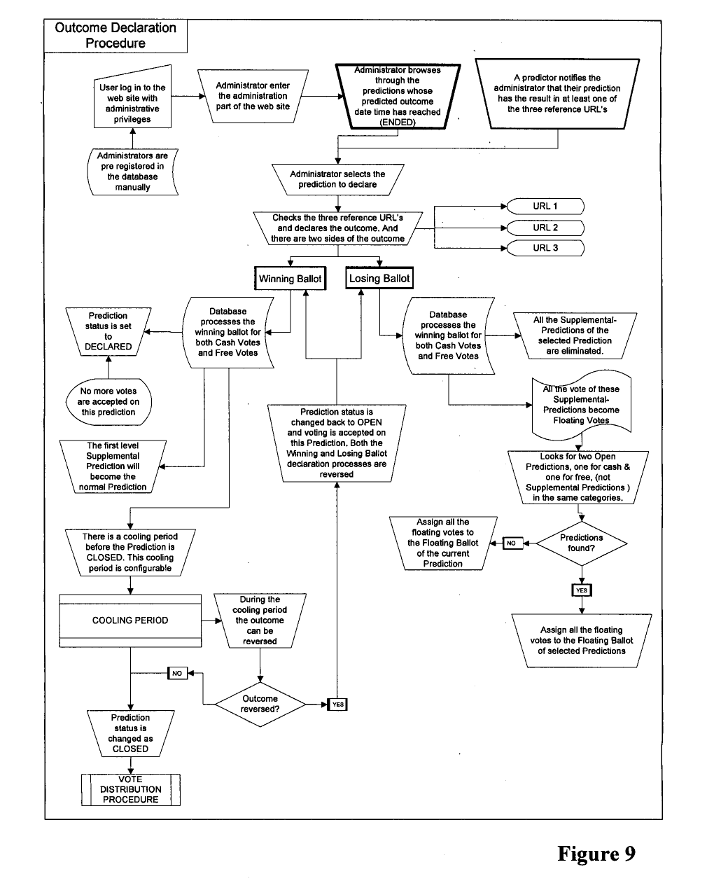

The outcome declaration procedure is set out in FIG. 9.

If the validation sources do not supply the necessary information, then the prediction is declared null and void and pledged votes are returned to voters. The deposit tariff is forfeited. This places the onus on identifying satisfactory validation sources on the predictor. This is the same procedure as removing a prediction.

If the validation sources are contradictory, a majority rule will apply, so that the outcome as reported on 2 URL's will be declared as the outcome.

When the site administrators have formally declared an outcome, the system operator is entitled to distribute votes and thereby calculate the number of votes available to it as a commission.

SMS may be used as a method of buying additional votes. The method of purchasing votes will be to send a message with content such as “Buy votes” to a short code.

Registered voters who provide their mobile phone number will be able to opt-in to receive alerts on a variety of subjects. Each alert will cost the voter 10 votes (not “Free votes”) and during the opt-in process this will be clearly indicated to the voter. The subjects that can be alerted to the voter include:
Submission of New House predictions.
Submission of New predictions by Elite voters.
Periodic Updates on predictions or supplemental predictions submitted by the voter, or any other prediction available on Foretal World.

Once a voter registers on the website, they can opt to receive a special download application onto their mobile. This application is despatched to feature phones as, for example, a Multi-Media Messaging system (MMS) attachment.

Once installed, the attachment permits voters to access a cut-down version of the site that can be accessed over GPRS. The same categories available to a voter via the web site are available, but only 5 predictions are available in a single View (compared with 25 in the Web site).
Overall or by Category, listed with soonest outcome first.
House predictions
Most active predictions
Newest predictions
Recent outcomes
predictions with outcomes in 3 hours, 3 days and 3 weeks.

A voter may also submit predictions and supplemental predictions via the application and review the status of these.

The application may be passed on by voters to their friends via Bluetooth, or via MMS. In either event, when the application is passed on, a record is made of the mobile phone from which it is despatched. When the application is installed and used by another voter on their own phone, it transmits, over GPRS, a record of the originator of the application. This enables the system operator to apply “Free votes” to the originating voter's account for each additional voter who receives the application from them.

When the mobile application is active on a voter's phone, and they have Bluetooth enabled, they will be alerted with the name of other voters who come into range. Voters of the mobile application will be able to review the summary profile of the fellow participants, and send them a short text message over Bluetooth.

In an exemplary voter profile page, a top group of fields contains standard voter name, login, time and date information, as well as providing space for a corporate logo.

The rest of the page is divided into two halves. The top half contains four (4) separate panels-Featured predictions, All predictions, My votes and My predictions. Where the section contains the word <link> this relates to information that can be presented in the bottom half of the page. In other words, if the ‘Won and Lost’ link is selected in the My votes panel, then the relevant information is presented in the bottom half of the page—and the tab for My votes is highlighted.

Correspondingly, a voter may decide to click on the tabs in the bottom half of the page, and see the information that way.

Thus the panels provide a method of controlling what information appears under the tabs.

According to certain embodiments of the present disclosure, leader boards may be provided on the system website.

According to an exemplary embodiment, there are three main types of Leaderboard.

Free Votes Leader board

Cash Votes Leader board

Overall Leader board

The Free and Cash prediction leader boards are only visible to registered users who have logged in.

The Overall leader board is openly available to all (ie. you don't have to be registered to view).

In the Free and Cash leader board, User Nick Name, and Country (with a little flag), States Value and Ranking will be displayed. In the Overall Leader Board, only User Nick Name, Country and overall Ranking will be displayed.

Free & Cash Votes leader board statistics for a specific member will be shown in the user profile as well.

For each leader, one or two statistics are evaluated first to determine the ranking is value of each member. When these values are the same, other leader board values are accessed to determine a specific ranking value. In the event that all the assessed values are the same, the member who registered earlier will be placed higher in the ranking.

For example, for Most predictions Made, the number of predictions Created is evaluated first, followed by Number of correct predictions, number of votes (Free+Cash), number of votes from other members (Free+Cash), and finally the account Id which determines who registered first.

In the leader board calculation, “Prediction” includes both predictions and supplemental predictions.

Users can be listed with the person who has created the most predictions at the top of the list (including both Free and Cash predictions because Cash predictions can accept Free Votes as well).

Users can be listed with the person who has cast the highest number of Free Votes at the top of the list (including both Free and Cash predictions because Cash predictions can accept Free Votes as well).

Users can be listed with the person who has created the highest percentage of accurate predictions at the top of the list. Where the percentage figure is equal to another member, then the one with the greatest number of correct predictions is placed higher in the ranking.

Users can be listed with the person whose predictions have attracted the greatest number of Free Votes from Other members (not including the votes from the Predictor) at the top of the list. Where the figures are equal, then the member who has created the greatest number of predictions is placed higher in the ranking.

Users can be listed with the user who has won the greatest amount of cash at the top of the list. In this case, ‘Cash Won’ can be calculated as ‘Commission’+‘Cash Votes won’−‘Cash Votes Loss’−‘Deposit Loss’.

There's a difference between 0 balance and people who haven't participated in Cash predictions. Those who haven't participated come at the bottom of the ranking table. For example,

Member A, won 30

Member B, won 20

Member C, lost 40

Member D, won 0

Member E,F,G, didn't participate.

The ranking would be as follows:

| Member | CashWon | RankingScore | Participated? |
|---|---|---|---|
| A | 30 | 1 | 1 |
| B | 20 | 2 | 1 |
| D | 0 | 3 | 1 |
| C | −40 | 4 | 1 |
| E | 0 | 5 | 0 |
| F | 0 | 5 | 0 |
| G | 0 | 5 | 0 |

Users can alternatively be listed with the one whose predictions have attracted the highest number of Cash Votes at the top of the list. Where the figures are equal, then the member who has created the greatest number of predictions is placed higher in the ranking.

The Leader Boards should give a ranking figure for each member in each view. Thus if a member is at the top of one leader board view he gets a 1, and if he is third in another he gets a 3.

The overall leader board is calculated by taking the sum of all ranking positions across the 6 types of leader board (4 free+2 cash), and giving an overall number. Where members are not eligible for any leader board, because they have not made any cash votes, or posted any predictions, they are automatically given a ranking 1 place below the lowest eligible member for that leader board. Thus, if there are 20 members on Foretal, and 15 of them have made Cash predictions, but 5 haven't, these 5 would be given an equal score of 16 on the Cash leader boards. The same is true for anyone who has not made a free prediction etc.

Thus, the highest possible score an individual could have is 6, i.e 1st place in 6 leader boards. This would give them first place in the overall leader board.

While the present disclosure has been described by way of example with reference to the above embodiments, it will be understood by one skilled in the art that these embodiments are not limiting and that numerous variations in the precise implementation of the system are possible, while still falling within the spirit and scope of the appended claims, and their equivalents.

1. A computer implemented method of enabling voting on predictions, comprising:
receiving a prediction, the prediction comprising a prediction statement and an outcome date;
receiving votes from a plurality of voters supporting and opposing the prediction;
determining the outcome; and
distributing votes of the losing voters to the winning voters.

2. A method according to claim 1, wherein the prediction is capable of being answered only with one of a Yes and a No answer.

3. A method according to claim 1, wherein the prediction is submitted by a registered voter.

4. A method according to claim 1, wherein the prediction is submitted by a system administrator.

5. A method according to claim 1, wherein the prediction includes the URLs of a plurality of websites for verifying the prediction outcome.

6. A method according to claim 5, wherein the plurality of websites comprises three websites.

7. A method according to claim 1, wherein a registered voter uses votes to submit the prediction.

8. A method according to claim 7, wherein the voter purchases the votes.

9. A method according to claim 1, wherein a voter submits a plurality of votes in respect of a prediction.

10. A method according to claim 1, wherein the votes of the losers are distributed to the winners in proportion to the share of total votes submitted by the winners in respect of the winning prediction.

11. A method according to claim 10, wherein a proportion of the votes of the losers is distributed to the system operator as commission.

12. A method according to claim 10, wherein a proportion of the votes of the losers is distributed to the predictor of the prediction as a success fee.

13. A method according to claim 10, wherein the votes are redeemable for financial value.

14. A method according to claim 1, wherein the prediction and votes are received at a computer server over a communications network.

15. A method according to claim 1, wherein the prediction is associated with one of a plurality of categories.

16. A method according to claim 1, further comprising associating one or more further predictions with the prediction, each of the one or more associated predictions comprising a supplemental prediction linked to one of the outcomes of the prediction with which it is associated.

17. A method according to claim 16, comprising converting the one or more supplemental predictions to a prediction once the outcome of the prediction with which the supplemental predictions are associated is determined.

18. A method according to claim 16, comprising eliminating a supplemental prediction that is contingent on an outcome that is determined to be incorrect.

19. A method according to claim 18, comprising converting votes associated with a supplemental prediction to floating votes.

20. A method according to claim 19, comprising transferring floating votes to a prediction that has the highest number of voters at the time that the supplemental prediction is eliminated.

21. A method according to claim 20, comprising distributing the floating votes proportionally as a bonus to voters who support the winning outcome when it is declared.

22. A system for enabling voting on predictions, comprising:
a computer configured to receive a prediction, the prediction comprising a prediction statement and an outcome date;
the computer further being configured to receive votes from a plurality of voters supporting and opposing the prediction;
wherein the computer is configured to received information specifying an outcome of the prediction and in response to the outcome, to distribute votes of the losing voters to the winning voters.
